(19) United States
(12) Patent Application Publication
(10) Pub. No.: US 2015/0346983 A1
(43) Pub. Date: Dec. 3, 2015

(54) TRAVEL TIME ESTIMATION AND ALERTING

(71) Applicant: Apple Inc., Cupertino, CA (US)

(72) Inventors: Scott ADLER, Saratoga, CA (US); Christine B. McGAVRAN, Pacifica, CA (US); Sean L. SEGUIN, San Jose, CA (US); Edward D. VOAS, Mountain View, CA (US)

(73) Assignee: Apple Inc., Cupertino, CA (US)

(21) Appl. No.: 14/292,327

(22) Filed: May 30, 2014

(51) Int. Cl. G06F 3/0484

(52) U.S. Cl. CPC G06F 3/04847; G06F 3/04842

(57) ABSTRACT

This application relates to travel time estimation. The travel time estimation can be performed by a travel time service of a computing device, and based on a calendar entry stored in the computing device. The travel time service can calculate the travel time estimation by using a location associated with a calendar entry and a location of the user prior to a time associated with the calendar entry. The travel time service can use the travel time estimation to alert the user of when to leave for the calendar event and when the user is going to be late for the event. Additionally, when the user is predicted to be late for the calendar event, the user can be prompted to notify the invitees of the calendar event that the user will be late.

### FIELD

The described embodiments relate generally to travel time estimations using a computing device. More particularly, the present embodiments relate to determining a travel time estimation at least based on an upcoming calendar entry.

### BACKGROUND

Modern computing devices have become increasingly convenient to use and carry throughout the daily life of a consumer. Many computing devices can provide a variety of data from numerous external sources as the consumer travels from day to day. One of the most useful features of modern computing devices are the navigation features that many devices are configured to include. These navigation features can, in many cases, find locations of interest to a user and guide the user to the location. As the modern consumer adopts a more transitory lifestyle, the data available for navigation features has been increasing, however, much of the data may not actually be utilized by the navigation features. In particular, various data that has been gathered over the ownership period of a device is often left unaccounted for. Typically, when a user carries a device with them during the course of ownership of the device, the device is exposed to a variety of environmental data and user data. As a user establishes a daily routine, such environmental data can include the navigation and route data acquired by the navigation system of the device each day of the life of the user. Moreover, the user data available to the device can be phone calls, text messages, favorite websites, contact lists, and any other data that can be stored on the device by a user. Despite the availability of this plethora of data, many device applications that gather this data often times do not share this data among themselves.

A device calendar is a place where much data from a user is received but is often not shared with other device applications. The device calendar typically can store appointments for a user, which can include additional stored parameters such as invitees, locations, and times for the event. Unfortunately, in many cases a user must enter this calendar data into not only the calendar application, but also any other relevant applications that may be used in association with the particular event being stored in the calendar. Specifically, as the event gets closer in time, the user may need to navigate to the location of the event, which will be performed by entering location data into a different application such as a map application. Should the user need to contact any of the invitees of the event, the user may have to look up the contact info of the invitees in a contacts application. These are just some of many examples where a user is often required to repeat an entry of data into multiple device applications. In some cases, the user is entering data that the device is capable of obtaining, even if the user has not entered the data directly into the device. These deficiencies can be frustrating to the majority of consumers who may be averted from less adaptive applications that do not recognize the trends of consumer lifestyles and device usage.

### SUMMARY

This paper describes various embodiments that relate to providing a travel time estimate to a user based on an upcoming calendar event. In some embodiments, a method for generating a leave alert for a user of a mobile device is set forth. The method can include performing the steps of, by a travel time service, determining an event location associated with an upcoming calendar event, and determining a user location that is a location of the user prior to the upcoming calendar event. Additionally, the method can include calculating the travel time estimate based on the event location and the user location. When a current time is approximately equal to an event time of the upcoming calendar event minus the travel time estimate minus a preparation time, the travel time service can cause a leave alert to be displayed at a user interface of the mobile device at a display time. The leave alert can include a leave time indicating when the user should initiate travel. The leave time can correspond to the preparation time at a time when the leave alert is displayed. The method can further include causing the leave time to decrease as the current time progresses toward the event time.

In other embodiments, a device is set forth. The device can include a processor and a memory storing instructions that, when executed by the processor included in the device, cause the processor to carry out steps that include determining an event location from a calendar entry and determining a user location that is a location of a user prior to an event time associated with the calendar entry. The steps can also include calculating a travel time estimate between the user location and the event location and comparing the travel time estimate to a time difference between a current time and the event time. Additionally, the steps can include causing an alert to be displayed based on the comparing, wherein the alert includes an option to notify an invitee of the calendar entry regarding a travel status of the user.

In yet other embodiments, a machine-readable non-transitory storage medium is set forth. The medium can store instructions that, when executed by a processor included in a computing device, cause the computing device to carry out steps that can include receiving, from a calendar service, an upcoming event location associated with an upcoming event and determining a user location that is the location of the user prior to a time of the upcoming event. The steps can also include calculating a travel time estimate based on the user location and the upcoming event location, and causing an alert to be displayed on a user interface of the computing device based on the travel time estimate. Additionally, the steps can include, when a navigation service of the computing device determines that the user is traveling toward the upcoming event location, causing the alert to be removed from the user interface.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIGS. 1A-1B illustrate a mobile device capable of receiving event data.

FIG. 2 illustrates a system of the mobile device for estimating travel time.

FIG. 3 illustrates a method for using a travel time service for determining a travel time estimate to a location associated with a calendar event.

FIG. 4 illustrates a travel time service comparing a calendar event to a predicted routine of a user compiled by the prediction manager.

FIGS. 5A-5B illustrate diagrams comparing a previous calendar to an updated calendar.

FIG. 6 illustrate a method for determining a starting location of a user when calculating a travel time estimate.

FIG. 7 illustrates a method for determining whether to use a predicted location or a current location to calculate a travel time estimate.

FIG. 8 illustrates a method for calculating a travel time estimate.

FIGS. 9A-9B illustrate a mobile device displaying a leave alert for an upcoming event.

FIG. 10 illustrates a method for displaying a leave alert on the user interface of the mobile device.

FIG. 11 illustrates a method of updating and suppressing a leave alert.

FIGS. 12A-12B illustrate a mobile device for displaying a late alert, according to some embodiments discussed herein.

FIG. 13 illustrates a method for providing a late alert to a user prior to an event.

FIG. 14 illustrates a method for providing a late notification to invitees of an event.

FIG. 15 illustrates a detailed view of a computing device that can be used to implement the various methods described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments discussed herein relate to estimating a travel time for a user of a computing device. The estimated travel time can be based on a calendar entry of an application on the computing device and a starting location of the user at a particular time. The calendar entry can include a location to which the user will be traveling prior to the time associated with the calendar entry. The starting location of the user can be derived from a predicted location of a user at a given time, another calendar entry indicative of where the user will be, emails, text messages, or any other suitable source for determining the location of the user prior to the location associated with the calendar entry. In some embodiments, the estimated travel time can be based on traffic conditions, various methods of transportation, or any other circumstances that can affect travel time. Additionally, if the user has already left for the location associated with the calendar entry, the estimated travel time can be updated according to the location of the user as the user travels toward the location.

The estimated travel time can be used to notify the user of when to leave for an event. A leave alert can be generated to notify the user that they should leave for a particular calendar event at a time that will make the user on time or early to the event, based on a preparation time set within the computing device. Moreover, the leave alert can be used to provide alerts for multiple events, and the leave alert can continue to alert the user to leave from any stops the user makes along the way to a calendar event location. If the user is going to be late, the alert can include an option to notify one or more attendees or invitees of the event. By choosing to notify an invitee, the computing device can send a message to each invitee included on the calendar event. The alert can be presented to a user while the computing device is in a locked mode and can be suppressed when the user acknowledges the alert. When the user is on the way to the calendar event location, the estimated travel time can be updated according to the remaining time the user will take to arrive at the calendar event location. The estimated travel time can be used to present the user with a variety of time estimations including an estimated arrival time, an amount of time the user will be late, and/or an amount of time the user will be early. Additionally, if the computing device determines that the user will be on time based on the current movement of the user, the computing device can refrain from presenting the user with any alerts related to travel time estimation in order to conserve battery and processing time.

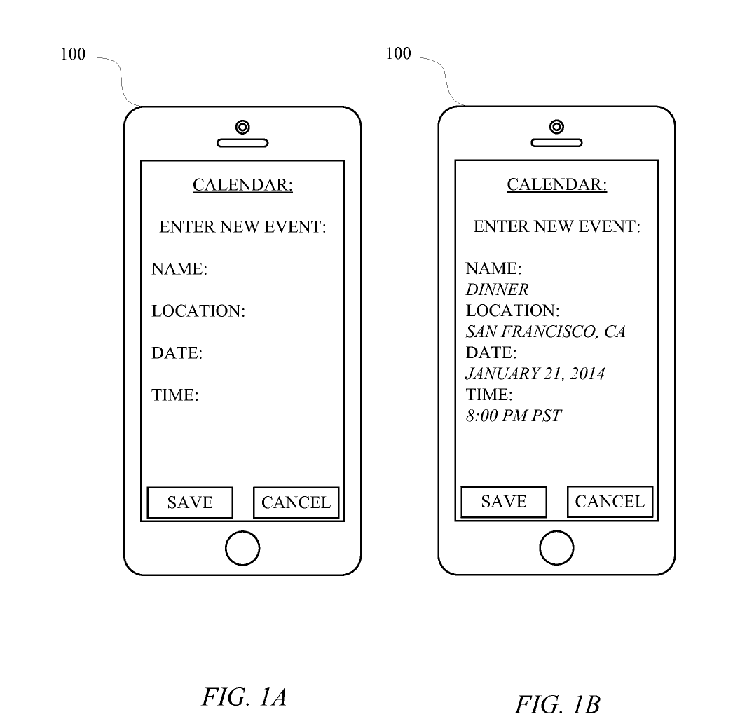

These and other embodiments are discussed below with reference to FIGS. 1-15; however, those skilled in the art will readily appreciate that the detailed description given herein with respect to these figures is for explanatory purposes only and should not be construed as limiting.

FIGS. 1A-1B illustrate a mobile device 100 capable of receiving event data. Specifically, FIG. 1A illustrates a user interface of a calendar application on a mobile device 100 for receiving a name, location, date, and time for a new event. The mobile device 100 can be any computing device operable by a consumer, not limited to a cell phone, desktop computer, media player, tablet computer, or any other suitable computing device. The calendar application can be a third party application or an application created by the manufacturer of the mobile device 100 in order to assist the user of the mobile device. In order to assist the user, the calendar application can store and organize numerous events for the user. The events can be associated with entries made by the user at the mobile device 100, or the events can be downloaded from another device or application. For example, a user can use a meeting organizer software at their office and the meeting organizer software can communicate over a network to the mobile device 100 to automatically update the calendar of the mobile device 100. In other embodiments, the user can give permission to another device or person to modify and update the calendar application of the mobile device 100.

FIG. 1B illustrates data entered into the fields of the calendar application of the mobile device 100. The calendar application can have any suitable number of fields and any suitable type of fields in order to assist user in managing their time. The fields included in FIG. 1B can be a name field for naming an event, a location field for providing an address of the event, a date field for providing a calendar date for an event, and a time for providing a time for the event. The name field can be configured to receive any suitable number and type of characters for a user to be adequately notified of what the event refers to. The location of the event can be a description of the location in which the event will take place, or any suitable location associated with the event. For example, as shown, the user may have a dinner event in San Francisco, Calif. (CA), and can therefore type the location of the event into the mobile device 100 accordingly. The user can also provide the location of the event by typing in a street address of the event (e.g., house number and street name). Additionally, the user can use an auto-fill feature to automatically fill in the location of the event based on one or more inputs at the calendar application. For example, the user can enter a name of the event and the location can be automatically filled in based on the most probable location of the event and/or data received from another network device. The date and time fields can be provided entries in a similar manner as the name and location fields. The date field can be provided any suitable number or type of characters indicative of a date (e.g., 1/21/14, 01.21.14, Jan. 1, 2014, etc.). Additionally, the time field can be provided any suitable number or type of characters indicative of a time (e.g., 8:00 PM PST, 800, 20:00, etc.).

Once the user has filled out some or all of the fields, a new event associated with the fields can be stored in a memory of the mobile device 100. The new event can also be stored in a remote device that can be in communication with the mobile device 100. A user can click to save the new event accordingly, or click cancel to restart the event making process. Upon the mobile device 100 receiving calendar event data (e.g., location, date, time, etc.), the calendar event data can be shared with other applications, devices, or otherwise used to assist the user in preparing for and arriving at the event.

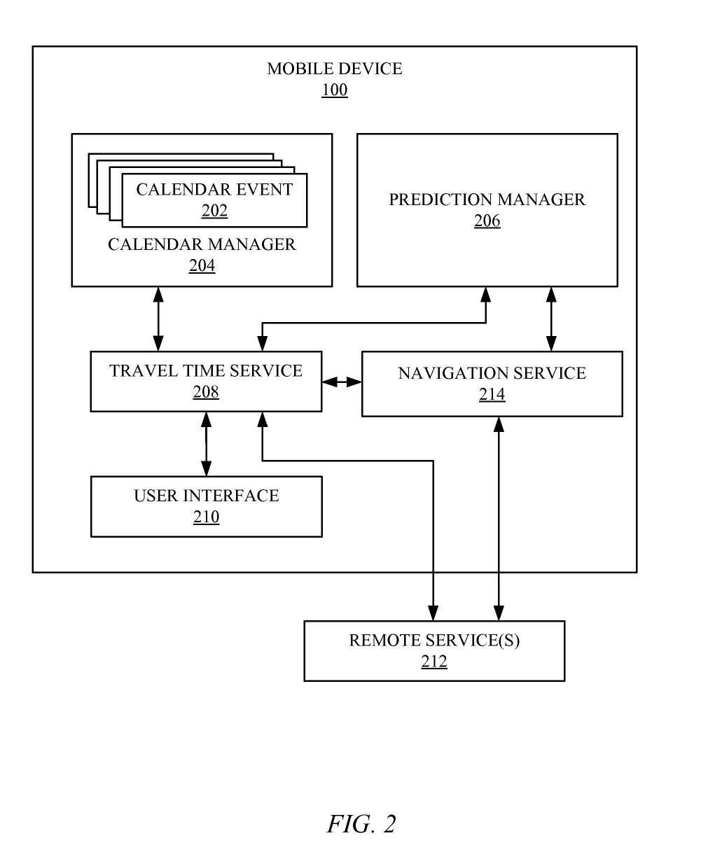

FIG. 2 illustrates a system of the mobile device 100 for estimating travel time. Specifically, FIG. 2 illustrates the mobile device 100 including a travel time service 208 for estimating travel times for various applications of the mobile device 100. The mobile device 100 can include a calendar manager 204 for managing each calendar event 202 of a plurality of calendar events. The calendar events 202 can correspond to various calendar event data as discussed herein. A prediction manager 206 is also included in the mobile device 100 for tracking and storing the conduct data of the user over the lifetime of the mobile device 100. Additionally, the prediction manager 206 can find trends in the conduct data in order to make predictions of what the user will be doing in the future. Such future predictions can be related to destinations the user will travel to, modes of transportation the user prefers, activities the user engages in, people the user contacts, and any other conduct the user performs related to the mobile device 100. The prediction manager 206 can communicate with a navigation service 214 to determine the geographic location of a user. The navigation service 214 can communicate with a global positioning system through one or more remote services 212 in order to determine the geographic coordinates of a user at various times. The travel time service 208 can use data from the calendar manager 204, remote service 212, navigation service 214, and the prediction manager 206 in order to provide travel time estimates to a user through a user interface 210.

The travel time estimates can be based on distances between a location indicated by a calendar event and a starting point indicated by either data from the calendar manager 204 or the prediction manager 206, as further discussed herein. For example, in some instances, the user may not have calendar events that indicate where the user will be prior to an upcoming calendar event. Therefore, the location of the user will be unclear prior to the upcoming event. However, if the user has a trend of being at a certain location at a time prior to the upcoming event, the prediction manager 206 can provide predicted location data to the travel time service 208. The travel time service can then calculate a distance between the predicted location and a location of the upcoming event, and provide an estimate of travel time to the user interface 210 for the user to see. Additionally, the travel time service 208 can use a remote service 212 in order to derive or modify a travel time estimate. The remote service 212 can be a web service such as a traffic or news server for providing traffic data to client devices such as mobile device 100. In this way, if the route between a predicted location and an event location is indicated to include a wreck event, according to the remote service, the travel time service 208 can adjust the travel time estimate based on the wreck event (e.g., the type or severity of the wreck event). Details of the wreck event can also be provided to the user in any suitable manner, such as with a leave alert or any other notification discussed herein. For example, the user can be notified of the type of wreck event and the severity of the wreck event while in transit or prior to moving toward the event location. Notifications providing the travel time estimate at the user interface 210 can occur concurrently with the generation of a calendar event (e.g., the upcoming event), a user-specified time before the event, a time of the calendar event minus the estimated travel time, or any other suitable time, as further discussed herein.

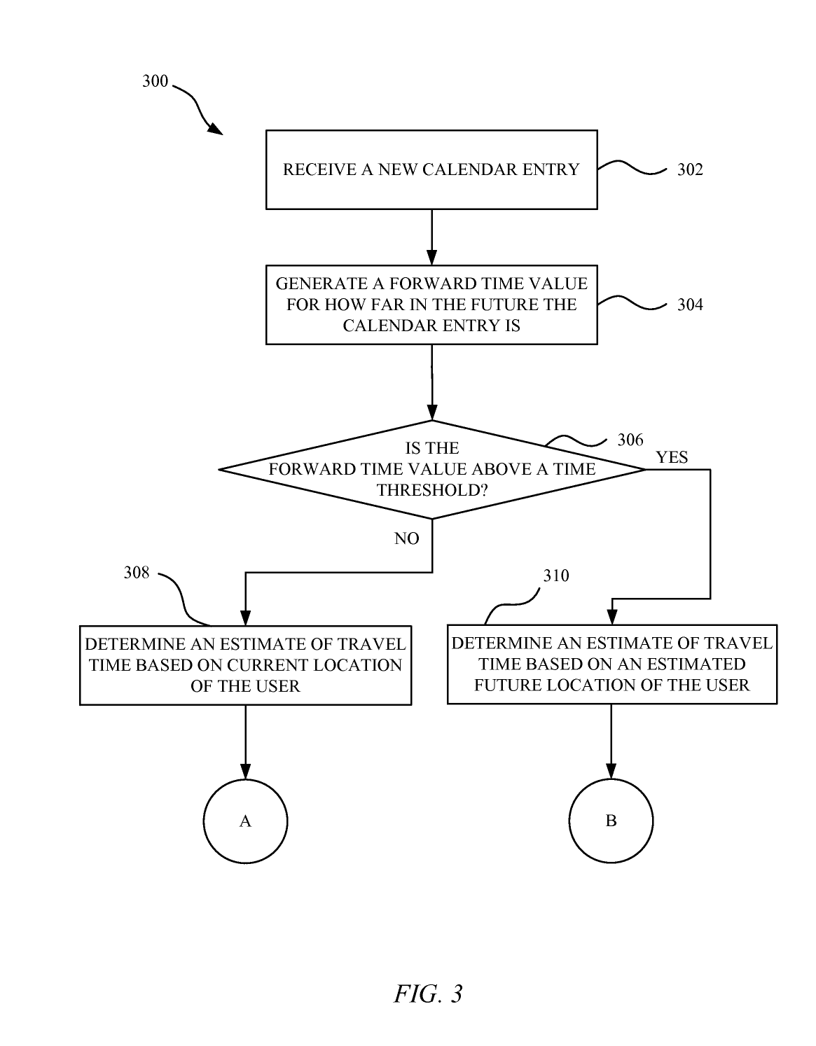

FIG. 3 illustrates a method 300 for using the travel time service 208 for determining a travel time estimate to a location associated with a calendar event. The method 300 can include a step 302 wherein the travel time service 208 receives a new calendar entry from the calendar manager 204. Based on a date and time value included in the calendar event, the travel time service 208 can estimate a forward time value for indicating how far in the future the calendar entry is. At step 306, the travel time service 208 can determine whether the forward time value is above a time threshold. The time threshold is provided for determining when to calculate a travel time estimate based on current location or based on an estimated future location. In this way, because considerable data processing is needed for both procedures, a benefit can be obtained by separating the tasks based on a time threshold. When the travel time service 208 determines that the forward time value is not above a time threshold, the travel time service 208 determines, at step 308, an estimate of travel time based on current location of the user. When the travel time service 208 determines that the forward time value is above a time threshold, the travel time service 208 can, at step 310, determine an estimate of travel time based on an estimated future location of the user. Method 300 can transition to other methods at node A and node B respectively, as further discussed herein.

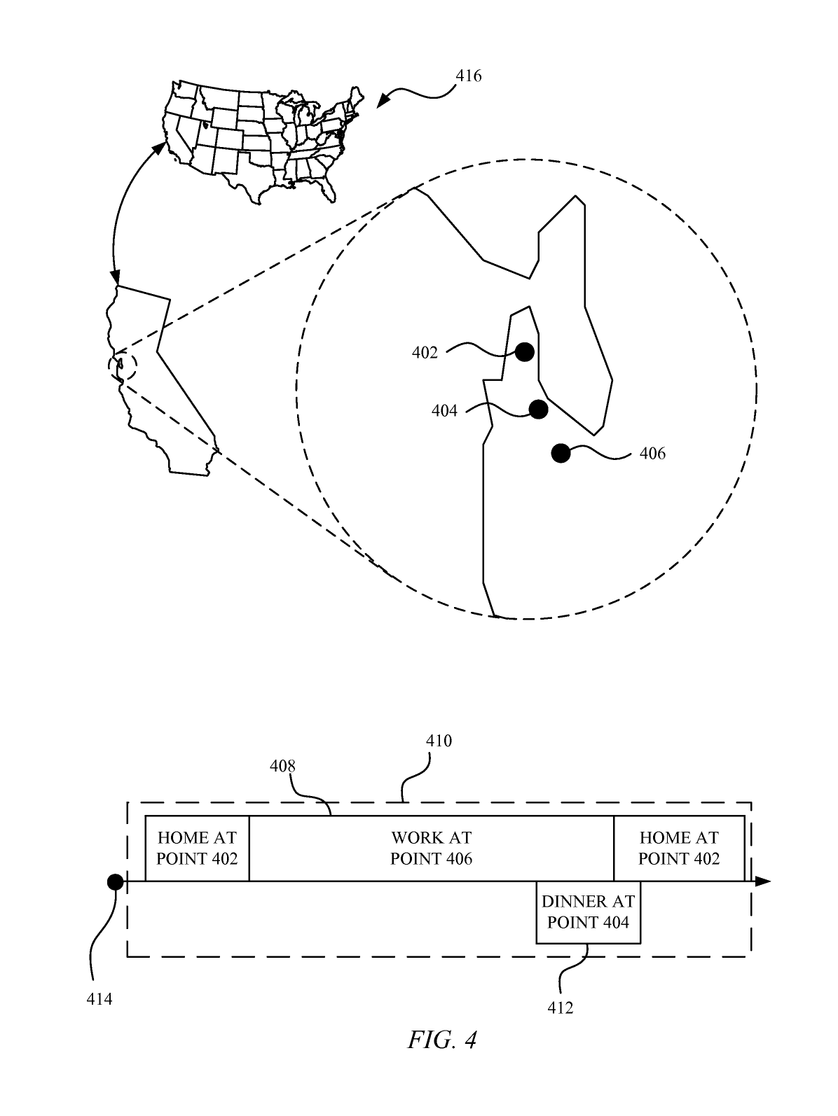

FIG. 4 illustrates the travel time service 208 comparing a calendar event 412 to a predicted routine 408 of a user compiled by the prediction manager 206. The diagram 410 represents a comparison between the predicted routine 408 of the user and a calendar event 412 over a period of time 414. The predicted routine 408 sets forth multiple geographic locations where the user can be found over a period of time 414 (e.g., a day). A map 416 is provided for clarity and to provide a visual representation of where the user can have a routine of being over the period of time 414. The location of the user can be provided by the navigation service 214 and/or remote service 212 by detecting the movements of the user over time. For example, a user can have the predicted routine 408 over the period of time 414 that includes being at home 402 during a first part of the period of time 414, being at point 406 during a second part of the period of time 414, and being back at home 402 during a third part of the period of time 414. A calendar event 412 can be entered into, or received at, the calendar manager 204 at point 404. The calendar event 412 can be, for example, a dinner at point 404. As illustrated in diagram 410, the calendar event 412 can occur at the period of time 414 where the user is predicted to be at point 406. Therefore, by receiving this predicted routine data from the prediction manager 206, the travel time service 208 can infer a starting point or location of the user from which the user will leave in order to arrive at an upcoming calendar event. By using the starting location and location of the upcoming calendar event, the travel time service 208 can accurately calculate a travel time estimate to present to the user. However, if the prior calendar event indicates a location of the user prior to the upcoming calendar event, the location indicated by the prior calendar event can be used for the starting location instead of the starting location indicated by the prediction manager 206.

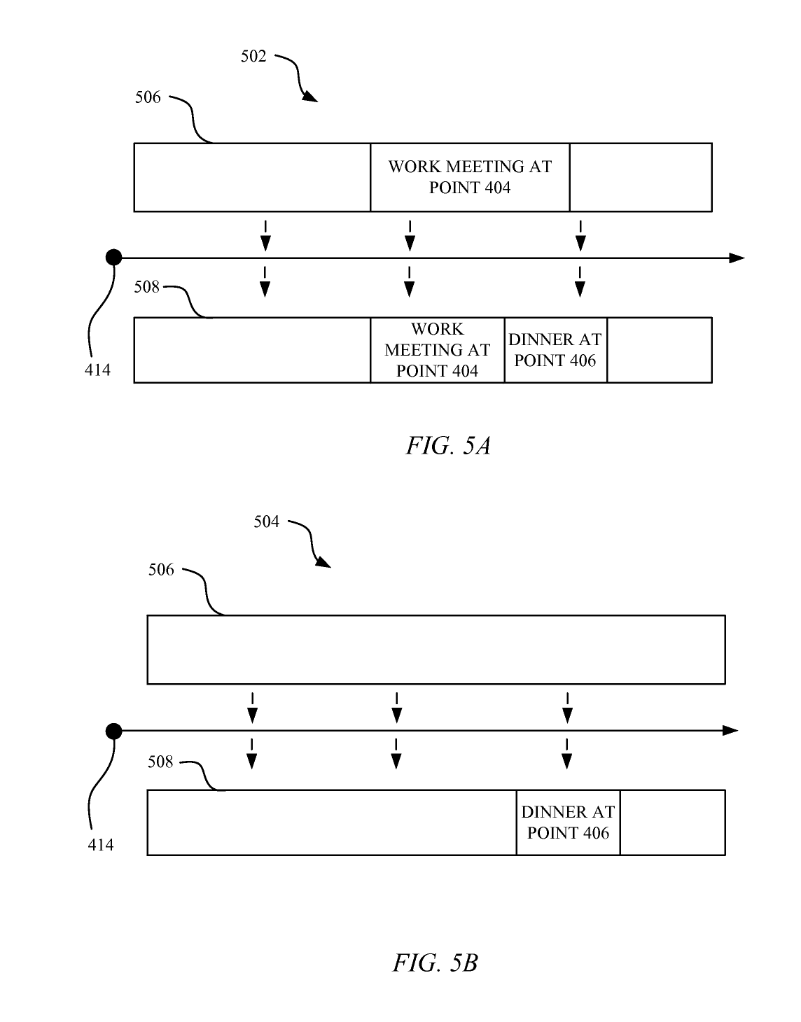

FIGS. 5A-5B illustrate diagrams comparing a previous calendar 506 to an updated calendar 508. Specifically, FIG. 5A illustrates a diagram 502 where the previous calendar 506 includes one previous calendar entry. The previous calendar entry, for example, can be a working meeting at point 404, wherein point 404 indicates a geographic location. An updated calendar 508 is illustrated as having an upcoming calendar event input by a user or by the mobile device 100. The updated calendar event can be a dinner at point 406, which follows the work meeting at point 404. Because of the sequence of the updated calendar event following the previous calendar entry, a location of the user prior to the updated calendar entry can be inferred from the updated calendar 508. Specifically, the travel time service 208 can determine a starting point from the calendar manager 204, which manages the calendar (previous calendar 506 and updated calendar 508). In the scenario illustrated in FIG. 5A, the travel time service 208 will calculate a travel time estimate based on a starting point (e.g., the work meeting at point 406) and a final location (e.g., the dinner at point 406). However, there can be instances where the calendar manager 204 does not have calendar events indicative of a starting location of a user prior to a calendar event, as shown in FIG. 5B.

In FIG. 5B, a diagram 504 is provided to illustrate an example of when the previous calendar 506 does not contain a calendar entry near the time of the updated calendar entry (e.g., dinner at point 406). Although there can be other calendar entries located on other portions of the updated calendar 508 not shown in FIG. 5B, there is no indication, at least from the updated calendar 508, of where the user will be. This can be due to no events being in the calendar near the updated calendar event, or because events in the calendar are not associated with a geographic location. In this scenario illustrated by FIG. 5B, a starting point at which the user will start traveling to the updated calendar event (e.g., dinner at point 406), the travel time service 208 will determine a starting point based on the prediction manager 206. In some embodiments, if the prediction manager 206 does not provide a starting point for the user, or the starting point is not accurate, the travel time service 208 can use a current location of the user. The current location of the user can be derived from the navigation service 214. In some embodiments, the calendar can take priority in determining the starting location of the user for calculating a travel time estimate. In other embodiments, the prediction manager 206 or the navigation service can take priority in determining the starting location of a user for calculating a travel time estimate.

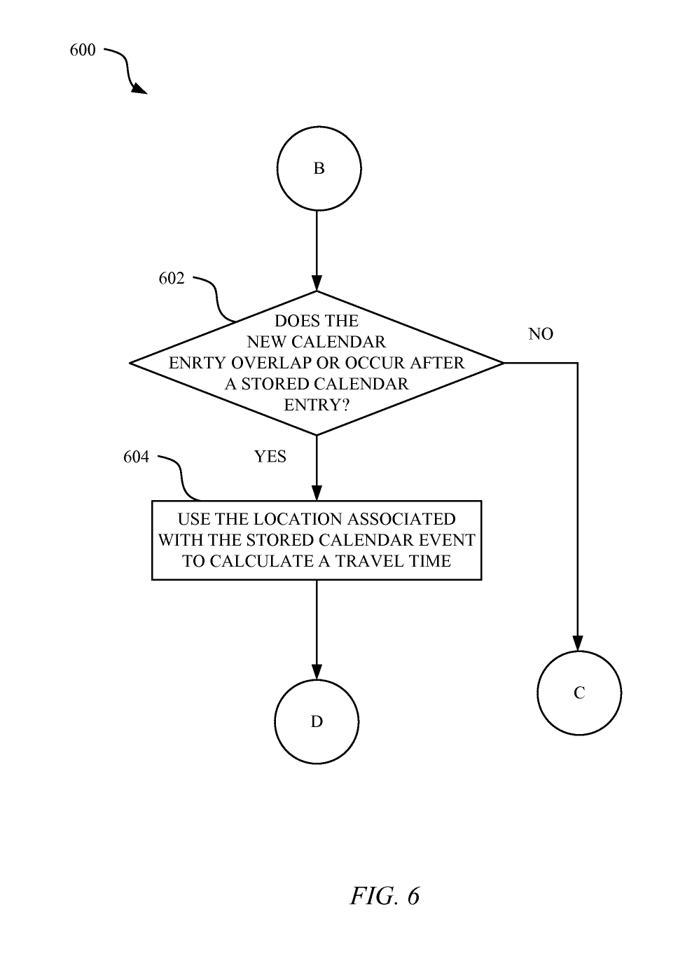

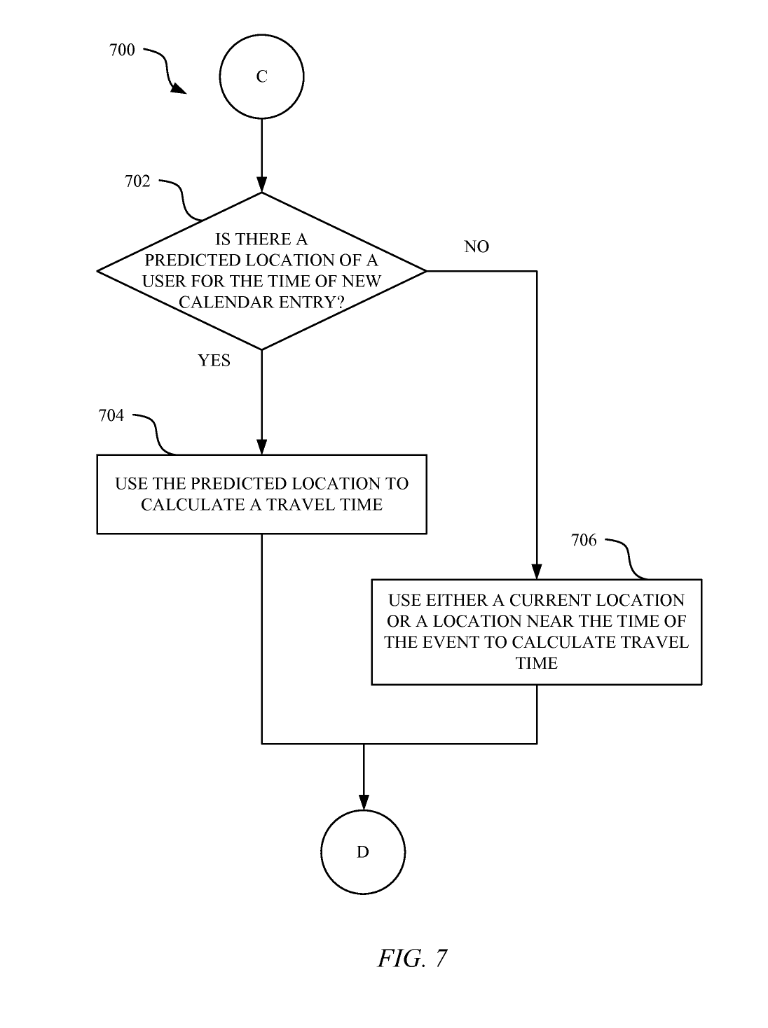

FIG. 6 illustrate a method 600 for determining a starting location of a user when calculating a travel time estimate. Specifically, FIG. 6 illustrates a method 600 for determining a starting location of a user depending on whether a new calendar entry exists proximate in time to another calendar entry of the calendar manager 204. The method 600 includes a node B, which is a continuation from node B of FIG. 3. Following node B, the travel time service 208 determines at step 602 whether the new calendar entry overlaps or occurs after a stored calendar entry. If the new calendar entry does overlap or occur after a stored calendar entry, the travel time service 208, at step 604, uses the location associated with the stored calendar event to calculate a travel time estimate for a user. The travel time estimate will therefore be calculated from the location associated with the stored calendar event to the location associated with the new calendar entry. If the new calendar event does not overlap or occur after a stored calendar entry, the travel time service 208 proceeds to node C at FIG. 7.

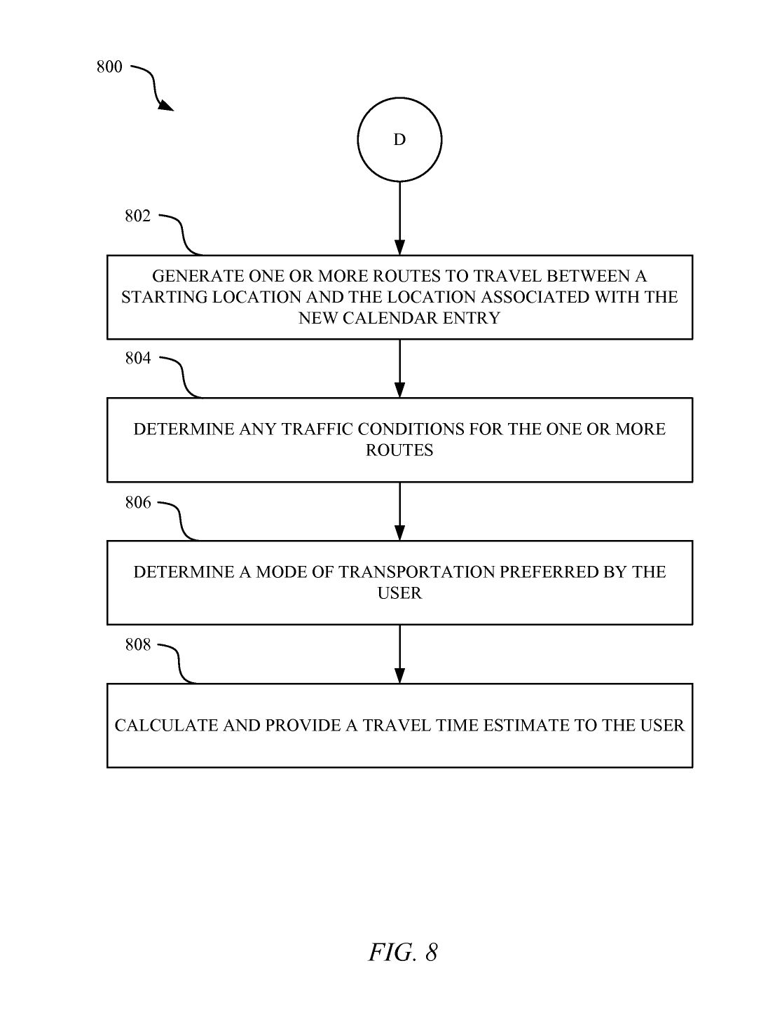

FIG. 7 illustrates a method 700 for determining whether to use a predicted location or a current location to calculate a travel time estimate. Specifically, FIG. 7 illustrates a method 700 for choosing what starting location to use depending on what information is available at the prediction manager 206. The method 700 includes a step 702 where the travel time service 208 determines whether there is a predicted location of a user at the time of the new calendar entry. If a location has been predicted by the prediction manager 206 for the user at the time of the new calendar entry (e.g., the time of the event), the travel time service 208 will, at step 704, use the predicted location as the starting location when calculating a travel time estimate. If a location has not been predicted by the prediction manager 206 for the user at the time of the new calendar entry, the travel time service 208 will, at step 706, use either a current location of the user or a user's location near the time of the event to calculate travel time. The current location and the user's location near the time of the event can be obtained from the navigation service 214. The user can be stationary or moving when the current location or the user's location near the time of event is obtained from the navigation service 214. In this way, the travel time service 208 can calculate a travel time estimate when the user is on their way to the location associated with the new calendar entry. After steps 704 and 706, the travel time service 208 can continue to node D, which continues at FIG. 8.

FIG. 8 illustrates a method 800 for calculating a travel time estimate. Specifically, FIG. 8 illustrates a method 800 for providing a travel time estimate to a user based on a starting location and a new calendar entry, as well as other factors for providing an accurate travel time estimate. At step 802, the travel time service 208 generates on or more routes for traveling between a starting location and the location associated with the new calendar entry. The starting location and location associated with the new calendar entry can be determined according to any of the embodiments discussed herein. In some embodiments, a route is obtained from the calendar event, which can include a field for storing a route to the location of the calendar event. At step 804, the travel time service 208 determines whether any traffic conditions exist for the one or more routes. The traffic conditions can include traffic jams, wrecks, congestion, traffic signs, weather affecting traffic, emergencies, news, construction, or any other condition or happening that can affect traffic. Additionally, the traffic conditions can be ranked by the impact the traffic condition has on the travel time estimation, in order for the travel time service 208 to provide the user with notifications regarding the most impactful traffic conditions. Routes can be ranked based on the overall time for the route. In this way, the highest ranked route, or the route with the smallest overall time, can be used for calculating a travel time estimate. If the route is long, the traffic conditions for only a portion of the route can be determined in order to save processing time. At step 806, the travel time service 208 determines a mode of transportation preferred by the user. The travel time service 208 can receive the preferred mode of transportation from the prediction manager 206 based on the commonly used modes of transportation by a user. For example, a user that commonly uses public transportation can be provided with a travel time estimate based on public transportation such as trains, subways, buses, etc. At step 808, the travel time service 208 calculates and provides a travel time estimate to the user. The travel time estimate can be calculated based on any suitable method for calculating travel time between multiple geographical locations. The travel time estimate can be calculated based on the preferred mode of transportation and the traffic conditions. For example, an event that is 20 miles away and an average speed limit between the starting location and the calendar event location is 50 miles per hour, can have a travel estimate time of 24 minutes. However, if there is congestion on the roads, the travel estimate time can be increased according to the severity of the congestion (e.g., 35 minutes). Additionally, if a user prefers to travel using public transportation such as buses, the travel time estimate can use a public transportation schedule to determine all the buses the user might need to take to arrive at the calendar event location. In this way, the total length of each trip and the waiting time for each bus can be added to create the travel time estimate (e.g., 15 minutes on a first bus, wait 6 minutes for a second bus, travel for 10 minutes on the second bus, for a total of 31 minutes for the travel time estimate).

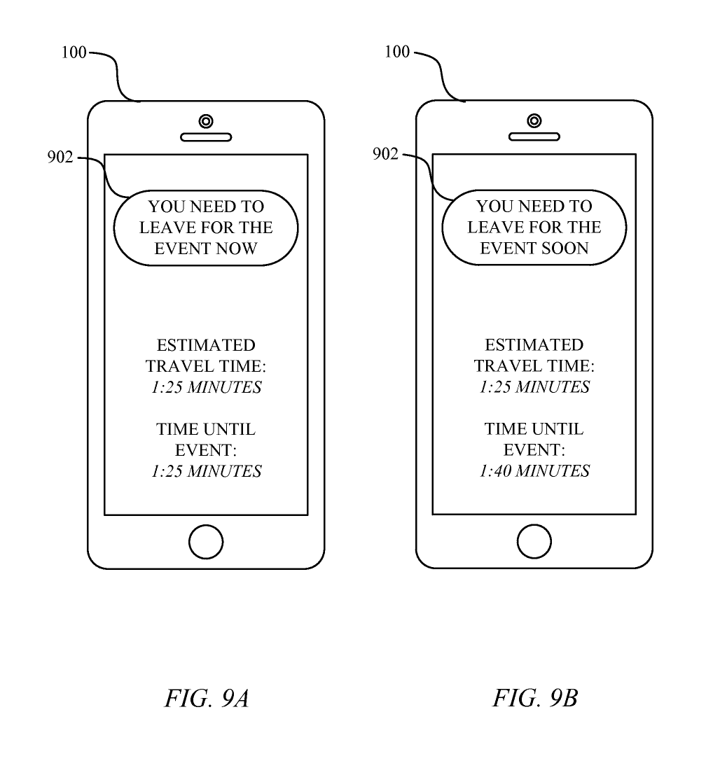

FIGS. 9A-9B illustrate a mobile device 100 displaying a leave alert for an upcoming event, as further discussed herein. Specifically, FIGS. 9A-9B illustrate a leave alert that includes a button 902 for acknowledging the leave alert. The leave alert can also include the travel time estimate and a time of the upcoming event, as discussed herein. FIG. 9A illustrates an embodiment of the leave alert where the leave alert is displayed at a time when the time until the event is equivalent or approximately the estimated travel time. FIG. 9B illustrates an embodiment of the leave alert where the leave alert is displayed at a time equivalent to the time of the event minus the estimated travel time minus a predetermined preparation time. For example, in FIG. 9B, the leave alert is displayed at a time equivalent to the event time minus the estimated travel time minus 15 minutes, wherein the 15 minutes can be the predetermined preparation time. The predetermined preparation time gives the user a time in which to prepare for traveling to the event. The predetermined preparation time can be set by a user of the mobile device 100, a party associated with the creation of the event, or otherwise set by the mobile device 100.

In some embodiments, the predetermined preparation time can be an adaptive preparation time in order to provide more accurate indicators of when the user should leave for an event. The adaptive preparation time can be based on a predicted and/or historic time a user to takes to begin traveling. When a user is within walking distance from public transportation or their parked car, the adaptive preparation time can be based on the time the user is predicted to take to walk from their current or predicted location to their car or public transportation. The adaptive preparation time can also be determined by the prediction manager 206, which can determine an average amount of time the user typically takes to leave or move towards an event after being notified to leave for an event. If the user takes an average amount of time to leave for an event after being alerted to leave, that average amount of time (i.e., the adaptive preparation time) can be added to the alert time in order to encourage the user to leave on time and not be late for the event.

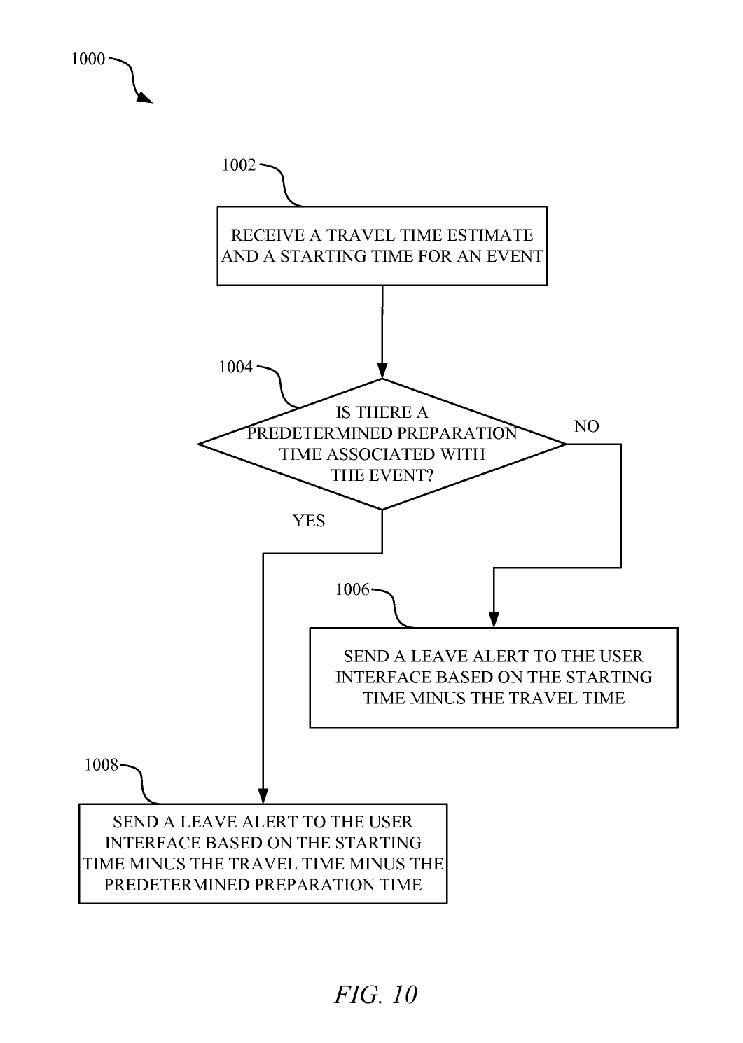

FIG. 10 illustrates a method 1000 for displaying a leave alert on the user interface 210 of the mobile device 100. Specifically, FIG. 10 illustrates a method 1000 for using the travel time service 208 to send a leave alert to the user interface 210 based in part on whether a predetermined preparation time has been associated with an event (i.e., a calendar event, an upcoming calendar event, etc.). The method 1000 can include a step 1002 where the travel time service 208 receives a travel time estimate and a starting time for an event. At step 1004, the travel time service 208 determines whether a predetermined preparation time is associated with the event. If a predetermined preparation time is associated with the event, the travel time service 208, at step 1008, sends a leave alert to the user interface 210 based on the starting time minus the travel time estimate minus the predetermine preparation time. If a predetermined preparation time is not associated with the event, the travel time service 208, at step 1006, sends a leave alert to the user interface 210 based on the starting time minus the travel time. In this way, the user can be notified of when to leave for an upcoming event based on the travel time estimate as calculated using the embodiments discussed herein. Additionally the alert can be provided when the user makes a stop on the way to an upcoming event, in order to remind the user that the user will be late if the user continues to stop and not move toward the upcoming event.

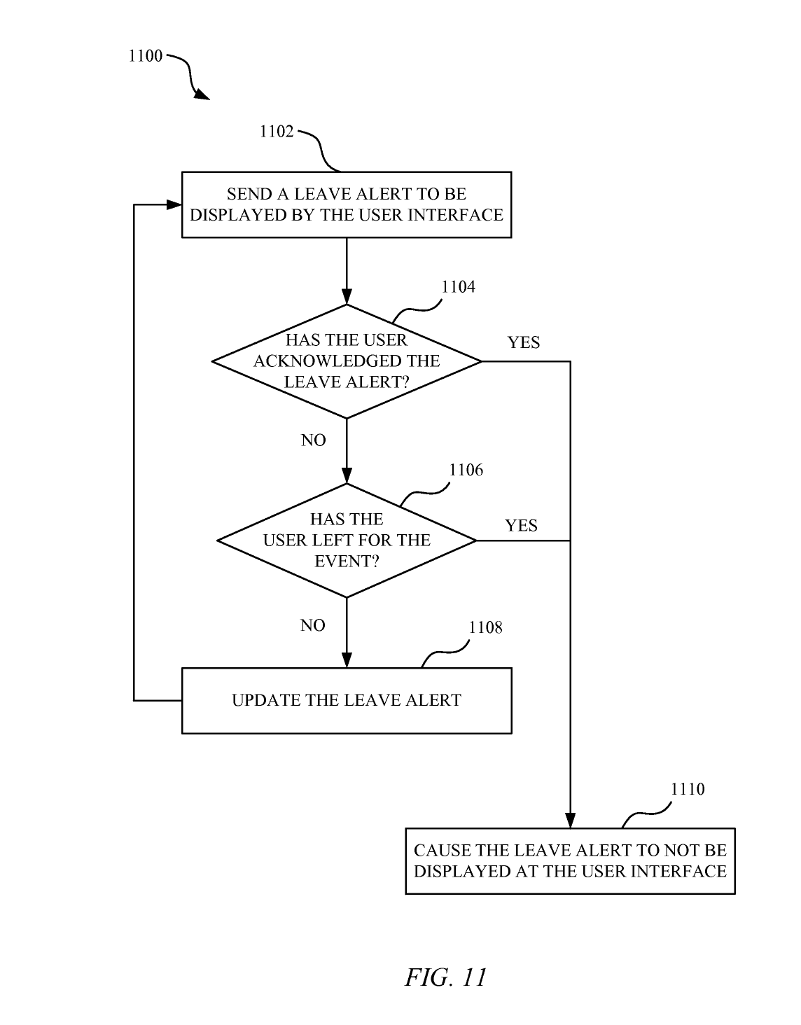

FIG. 11 illustrates a method 1100 of updating and suppressing a leave alert. Specifically, FIG. 11 illustrates a method 1100 for using the travel time service 208 for updating and suppressing a leave alert based on whether the user has acknowledged the leave alert or the user has left for the event associated with the leave alert. At step 1102, the travel time service 208 can send a leave alert to be displayed by the user interface 210. The travel time service 208 can, at step 1104, determine whether the user has acknowledged the leave alert. If the user has acknowledged the leave alert, the travel time service 208 can cause the leave alert to not be displayed at the user interface, at step 1110. The user can acknowledge the leave alert in any suitable manner not limited to touching the user interface 210, using a voice protocol of the mobile device 100, moving the mobile device 100, or otherwise providing an indication to the mobile device 100. If the user has not acknowledged the leave alert at step 1104, the travel time service 208 can proceed to step 1106. At step 1106, the travel time service 208 can determine whether the user has left for the event. The determination of whether the user has left for an event can be based on a current location of the user and whether the user is physically moving towards the event, which can be made available by the navigation service 214. Additionally, whether the user has left for the event can be based on where the user is currently located compared to a predicted location of the user, as determined by the prediction manager 206. If the user has left for the event, the travel service can cause the leave alert to not be displayed at the user interface 210, at step 1110. If the travel time service 208 determines that the user has not left for the event, the travel time service 208 can update the leave alert, at step 1108, and thereafter send the leave alert to be displayed by the user interface 210, at step 1102.

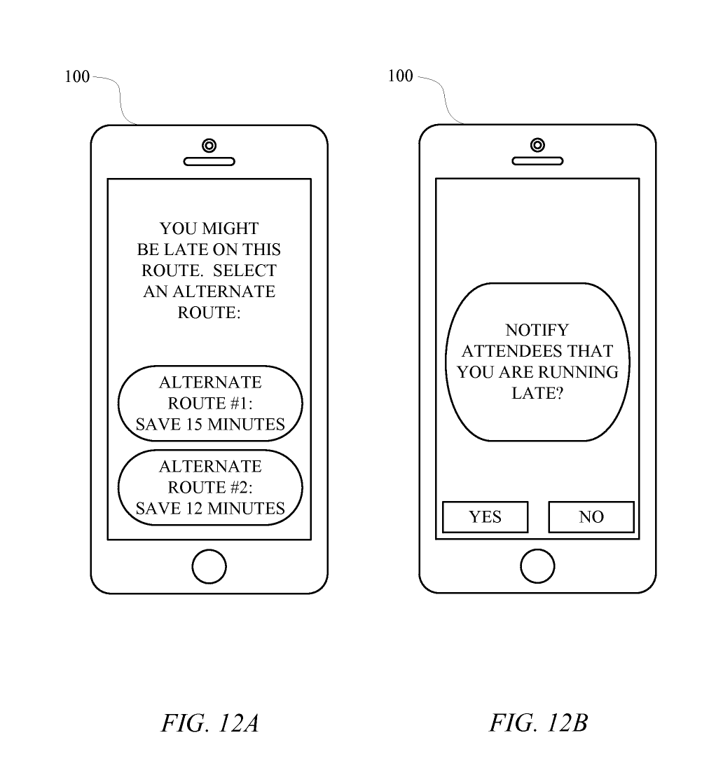

FIGS. 12A-12B illustrate a mobile device 100 for displaying a late alert, according to some embodiments discussed herein. Specifically, FIG. 12A illustrates a mobile device 100 displaying a late alert that includes alternate routes. A travel time service 208 on the mobile device 100 can determine whether a user has left for an upcoming event, and displays a late alert if the user is traveling to the event and is predicted to be late for the event. If the user is predicted to be late for the event, the travel time service 208 can determine alternate routes for the user to take and provide a time estimate for how much time the user will save by taking each route. In some embodiments, the late alert can display how much time each route will take to get to the event and/or approximately how late or early the user can be by taking each of the routes that are displayed. FIG. 12B illustrates a mobile device 100 displaying a late alert that includes an option to alert invitees of the event that the user will be late. The invitees can be compiled from the calendar manager 204 so that if the user would like to notify the invitees that the user will be late, each invitee can be sent a message indicating that the user will be late. The user can choose a single invitee to message, or multiple invitees to message based on the preference of the user. For example, a user interface of the mobile device 100 can be caused to display a list of invitees of a calendar event, and the user can select specific invitees to receive a message that the user will be late. The message can be sent from the travel time service 208 to a remote service 212. The remove service 212 can include a message service such as email, text message, voice mail, or any other suitable messaging service. The user can click “YES” to send late notification notices to the invitees, or “NO” to suppress the late alert.

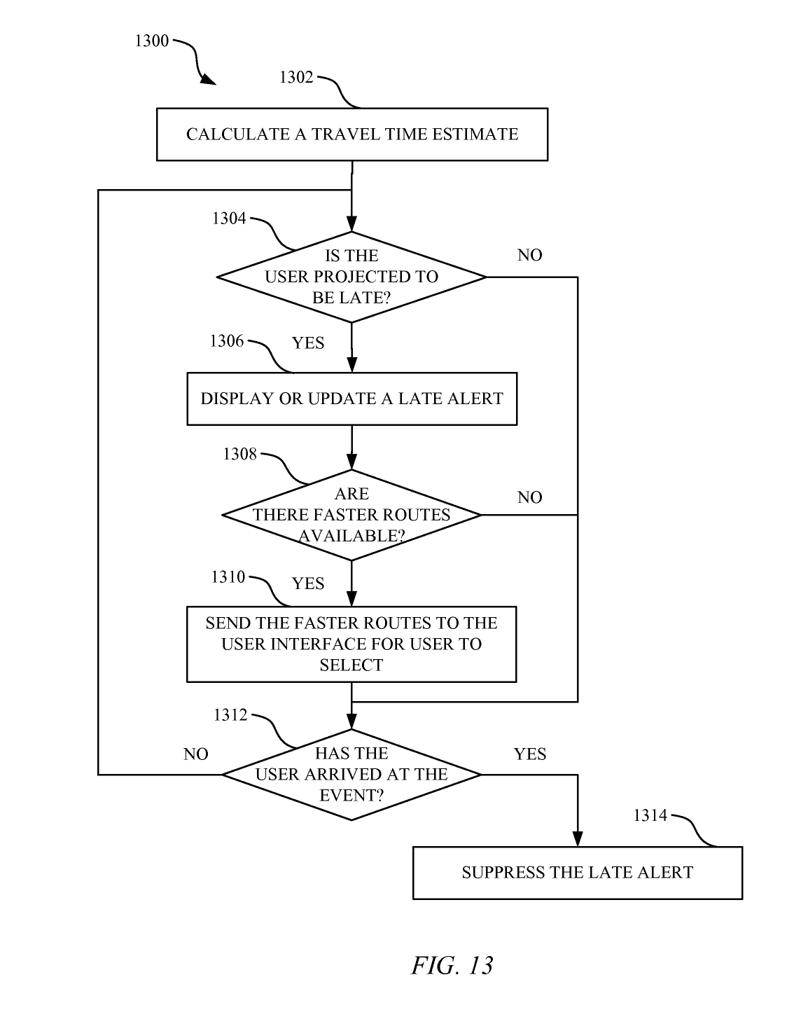

FIG. 13 illustrates a method 1300 for providing a late alert to a user prior to an event. Specifically, FIG. 13 illustrates a method 1300 for using a travel time service 208 to generate and update a late alert while the user is traveling and based on whether the user is projected to be late. The method 1300 can include a step 1302 where the travel time service 208 calculates a travel time estimate according to any of the embodiments discussed herein. Based on the travel time estimate and a time of the event, the travel time service 208 can determine, at step 1304, whether the user is projected to be late to the event. If the user is projected to not be late for the event, the travel time service 208 can proceed to step 1312 where the travel time service 208 can determine whether the user has arrived at the event. The user can be determined to have arrived at the event by comparing a current location of the user, calculated by the navigation service 214, to the location of the event. If the user is projected to be late, the travel time service 208 can display or update a late alert. The late alert can include text telling the user that they are projected to be late, an estimate of how late they will be, an estimate of how long it will take for the user to get to the event, as well as any other suitable information a user may desire while attempting to arrive at the event location. Thereafter, the travel time service 208, at step 1308, can determine whether there are any faster routes available. The faster routes can be routes that allow the user to arrive at an event location at a time that is earlier than the current predicted time the user will arrive at the location. The faster routes can be based on calculations performed at the travel time service 208, navigation service 214, and/or the remote service 212. If there are no faster routes currently available, the travel time service 208 can proceed to step 1312, otherwise the travel time service 208 can proceed to step 1310 where the faster route(s) is sent to the user interface 210 to be displayed for the user to select. If the user selects a faster route, the user will be navigated by the mobile device 100 based on the faster route. The travel time service 208 can then, at step 1312, determine whether the user has arrived at the event. If the user has not arrived at the event, the travel time service 208 will continue to step 1304, otherwise the late alert will be suppressed by the travel time service 208, at step 1314.

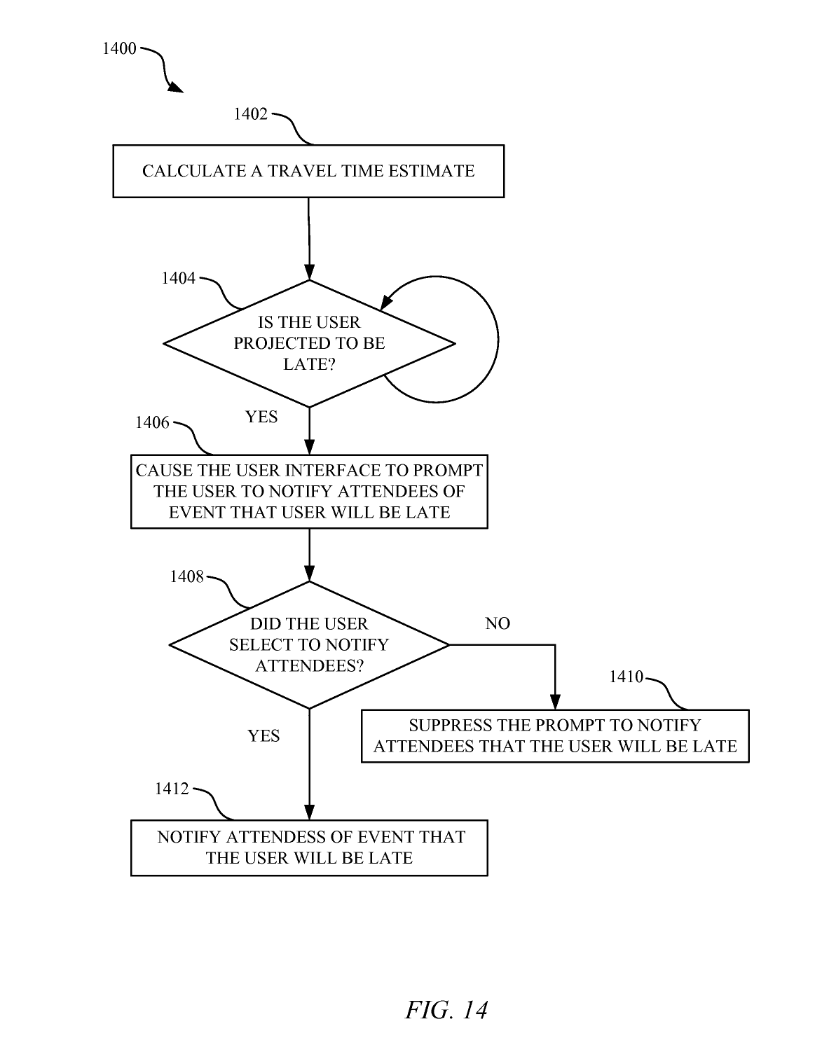

FIG. 14 illustrates a method 1400 for providing a late notification to invitees of an event. Specifically, FIG. 14 illustrates a method 1400 for using a travel time service 208 to issue late notifications to invitees of an event to which the user can be traveling to. The method 1400 can include a step 1402 of calculating a travel time estimate using the travel time service 208 according any of the embodiments discussed herein. At step 1404, the travel time service 208 can determine whether the user is projected to be late, according to any of the embodiments discussed herein. If the use is not projected to be late, the travel time service 208 can continually determine whether the user is projected to be late (i.e., step 1404 can loop), at least until time of the event. If the user is projected to be late, the travel time service 208 can, at step 1406, cause the user interface 210 to prompt the user to notify the invitees of the event that the user will be late. The invitees of the event can be any persons associated with the event, as indicated by the calendar manager 204, the remote service 212, or the prediction manager 206, or through any suitable manner for determining invitees of an event. The travel time service 208 can, at step 1408 determine whether the user selected to notify the invitees of the event that the user will be late. This determination can be based on an input received at the user interface 210. If the user did not select to notify the invitees or otherwise did not acknowledge the prompt to notify invitees, the travel time service 208 can suppress the prompt to notify invitees that the user will be late. Otherwise, if the user selects to notify invitees at the user will be late, the travel time service 208, at step 1412, can notify the invitees of the event that the user will be late according to the embodiments discussed herein.

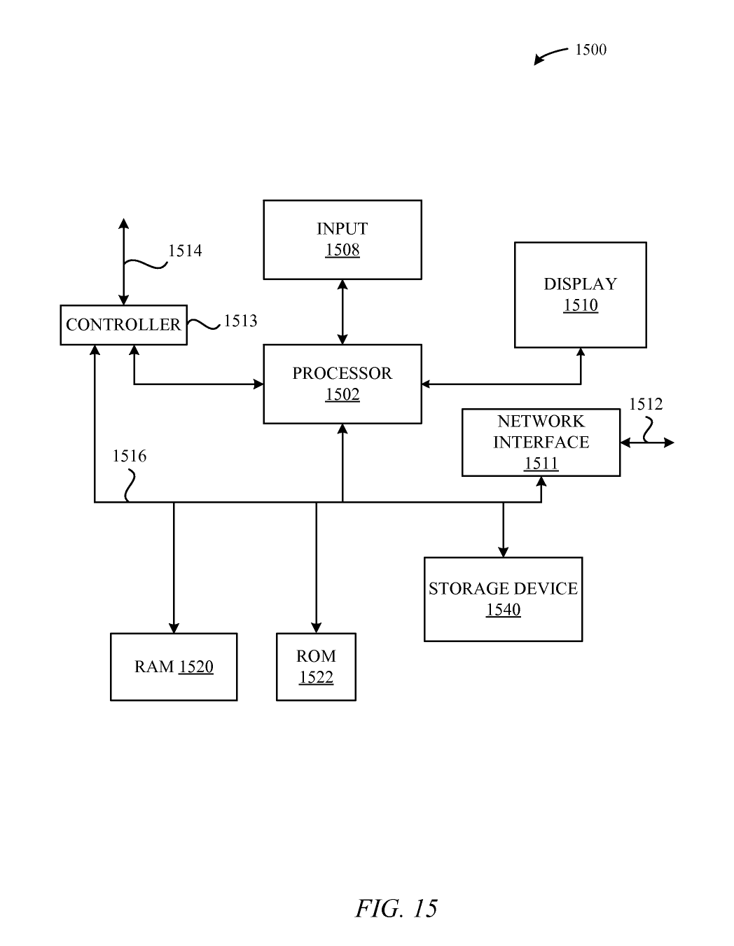

FIG. 15 illustrates a detailed view of a computing device 1500 that can be used to implement the various components described herein, according to some embodiments. In particular, the detailed view illustrates various components that can be included in the mobile device 100 as illustrated in FIG. 1. As shown in FIG. 15, the computing device 1500 can include a processor 1502 that represents a microprocessor or controller for controlling the overall operation of computing device 1500. The computing device 1500 can also include a user input device 1508 that allows a user of the computing device 1500 to interact with the computing device 1500. For example, the user input device 1508 can take a variety of forms, such as a button, keypad, dial, touch screen, audio input interface, visual/image capture input interface, input in the form of sensor data, etc. Still further, the computing device 1500 can include a display 1510 (screen display or user interface) that can be controlled by the processor 1502 to display information to the user. A data bus 1516 can facilitate data transfer between at least a storage device 1540, the processor 1502, and a controller 1513. The controller 1513 can be used to interface with and control different equipment through and equipment control bus 1514. The computing device 1500 can also include a network/bus interface 1511 that couples to a data link 1512. In the case of a wireless connection, the network/bus interface 1511 can include a wireless transceiver.

The computing device 1500 can also include a storage device 1540, which can comprise a single disk or a plurality of disks (e.g., hard drives), and includes a storage management module that manages one or more partitions within the storage device 1540. In some embodiments, storage device 1540 can include flash memory, semiconductor (solid state) memory or the like. The computing device 1500 can also include a Random Access Memory (RAM) 1520 and a Read-Only Memory (ROM) 1522. The ROM 1522 can store programs, utilities or processes to be executed in a non-volatile manner. The RAM 1520 can provide volatile data storage, and stores instructions related to the operation of the mobile device 100.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for generating a leave alert for a user of a mobile device, the method comprising:
determining an event location associated with an upcoming calendar event;
determining a user location that is a location of the user prior to the upcoming calendar event;
calculating the travel time estimate based on the event location and the user location; and
when a current time is approximately equal to an event time of the upcoming calendar event minus the travel time estimate minus a preparation time:
causing the leave alert to be displayed at a user interface of the mobile device at a display time, wherein the leave alert includes a leave time indicating when the user should initiate travel, and the leave time corresponds to the preparation time at a time when the leave alert is displayed; and
causing the leave time to decrease as the current time progresses toward the event time.

2. The method of claim 1, further comprising:
causing a calendar service to determine whether the upcoming calendar event overlaps or followings a current calendar event stored at the mobile device; and
when the upcoming calendar event overlaps or follows the current calendar event, use a location associated with the current calendar event as the user location.

3. The method of claim 1, further comprising:
causing a prediction service to derive a predicted location of where the user will be prior to the upcoming calendar event; and
using the predicted location as the user location.

4. The method of claim 1, further comprising:
causing a prediction manager to determine a preferred mode of transportation for the user based on a transportation history managed by the prediction manager; and
calculating the travel time estimate further based on the preferred mode of transportation.

5. The method of claim 1, wherein the preparation time is a time designated by the user for preparing to initiate travel; and determining the user location includes querying a calendar service and a prediction service.

6. The method of claim 1, wherein calculating the travel time is further is based on traffic conditions as determined by a navigation service of the mobile device.

7. A device, comprising:
a processor; and
a memory storing instructions that, when executed by the processor included in the device, cause the processor to carry out steps that include:
determining an event location from a calendar entry;
determining a user location that is a location of a user prior to an event time associated with the calendar entry;
calculating a travel time estimate between the user location and the event location;
comparing the travel time estimate to a time difference between a current time and the event time; and
causing an alert to be displayed based on the comparing, wherein the alert includes an option to notify an invitee of the calendar entry regarding a travel status of the user.

8. The device of claim 7, wherein the alert is displayed based on whether the travel time estimate is equal to or greater than the time difference.

9. The device of claim 7, wherein the alert includes an option to notify multiple invitees of the calendar entry and provide an estimated time of arrival of the user based on the travel time estimate.

10. The device of claim 7, wherein the alert is displayed at a time approximately equal to the event time minus the travel time estimate minus an adaptive preparation time, wherein the adaptive preparation time is a predicted time the user will take to prepare to initiate travel.

11. The device of claim 10, wherein the alert includes a recommended time for the user to leave by in order to arrive at the event location at or near the event time.

12. The device of claim 7, wherein the alert includes a recommended time for the user to leave by that is updated until the user acknowledges the alert or leaves for the event location.

13. The device of claim 7, wherein the alert includes a recommended time for the user to leave by, and the alert is removed when an indication is received that the user is moving towards the event location.

14. A machine-readable non-transitory storage medium storing instructions that, when executed by a processor included in a computing device, cause the computing device to carry out steps that include:
receiving, from a calendar service, an upcoming event location associated with an upcoming event;
determining a user location that is the location of the user prior to a time of the upcoming event;
calculating a travel time estimate based on the user location and the upcoming event location;
causing an alert to be displayed on a user interface of the computing device based on the travel time estimate; and
when a navigation service of the computing device determines that the user is traveling toward the upcoming event location:
causing the alert to be removed from the user interface.

15. The machine-readable non-transitory storage medium of claim 14, further including the step of, when the travel time estimate is greater than a difference between the time of the upcoming event and a current time, the alert includes an indication that the user is predicted to be late.

16. The machine-readable non-transitory storage medium of claim 14, wherein the alert includes an alternate route based on data provided by a navigation service.

17. The machine-readable non-transitory storage medium of claim 14, wherein the alert includes a prompt to notify an invitee of the upcoming event when the travel time estimate exceeds a time period between the time of the upcoming event and a current time.

18. The machine-readable non-transitory storage medium of claim 14, wherein the user location is determined by a prediction service that stores a routine of the user, and the routine is based on previous locations of the user generated by the navigation service.

19. The machine-readable non-transitory storage medium of claim 14, wherein the travel time estimate is based on traffic conditions affecting a portion of a route between the user location and the upcoming event location.

20. The machine-readable non-transitory storage medium of claim 14, wherein the alert includes a value for the travel time estimate, and the value for the travel time estimate is updated until the user acknowledges the alert.
